(19) United States
(12) Patent Application Publication
(10) Pub. No.: US 2020/0118107 A1
(43) Pub. Date: Apr. 16, 2020

(54) SALES DATA PROCESSING APPARATUS

(71) Applicant: TOSHIBA TEC KABUSHIKI KAISHA, Tokyo (JP)

(72) Inventor: Yuichi OGAWA, Izunokuni Shizuoka (JP)

(21) Appl. No.: 16/599,716

(22) Filed: Oct. 11, 2019

(30) Foreign Application Priority Data
Oct. 16, 2018 (JP) 2018-195010

(51) Int. Cl. G06Q 20/20; G06Q 20/04; G07G 5/00; G07G 1/00

(52) U.S. Cl. CPC G06Q 20/209; G06Q 20/0453; G07G 1/0009; G07G 1/0018; G07G 5/00

(57) ABSTRACT

A sales data processing system includes a wireless communication interface and a controller. The wireless communication interface is configured to receive customer preference information from a customer terminal. The customer preference information includes a processing condition associated with a customer preference. The controller is configured to determine whether the processing condition associated with the customer preference is satisfied and control a display to display a screen indicating the customer preference upon determining that the processing condition has been satisfied.

### CROSS-REFERENCE TO RELATED APPLICATION

This application is based upon and claims the benefit of priority from Japanese Patent Application No. 2018-195010, filed on Oct. 16, 2018, the entire contents of which are incorporated herein by reference.

### FIELD

Embodiments described herein relate generally to a sales data processing apparatus.

### BACKGROUND

In a related art, an electronic receipt system is known. In such a system, an electronic receipt is transmitted to a portable terminal carried by a customer, instead of issuing a paper receipt, when settlement of a transaction is completed. However, if the customer does not want the electronic receipt, a paper receipt is issued from the point of sale (POS) terminal. It may be difficult to determine at the POS terminal at the time of the transaction whether or not the customer is a current member of the electronic receipt system. Thus, a store clerk may be required to input the request for an electronic receipt for the customer at the POS terminal for every sales transaction. However, it is a burden for the store clerk to have to input such a request for the customer each time.

### DESCRIPTION OF THE DRAWINGS

FIG. 1 is a schematic diagram illustrating a customer request system according to an embodiment.

FIG. 2 is a block diagram illustrating a hardware structure of a customer terminal.

FIG. 3 is a diagram illustrating a data structure of customer information.

FIG. 4 is a block diagram illustrating a hardware structure of a POS terminal.

FIG. 5 is a block diagram illustrating functional components of the customer terminal and the POS terminal in the customer request system.

FIG. 6 is a flowchart depicting a request handling processing performed by the POS terminal.

### DETAILED DESCRIPTION

According to an embodiment, a sales data processing system includes a wireless communication interface and a controller. The wireless communication interface is configured to receive customer preference information from a customer terminal. The customer preference information includes a processing condition associated with a customer preference. The controller is configured to determine whether the processing condition associated with the customer preference is satisfied and to control a display to display a screen indicating a customer preference upon determining that the processing condition is satisfied.

Hereinafter, an example embodiment of a sales data processing apparatus is described with reference to the accompanying drawings. The sales data processing apparatus of the present embodiment is applied to a POS terminal installed in a retail store.

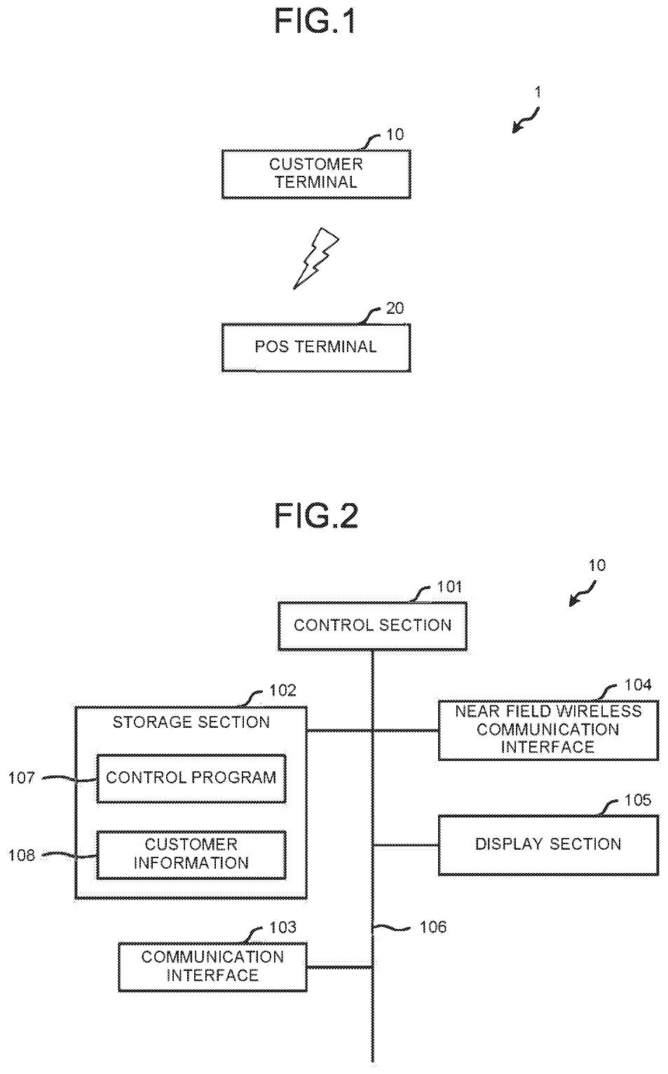

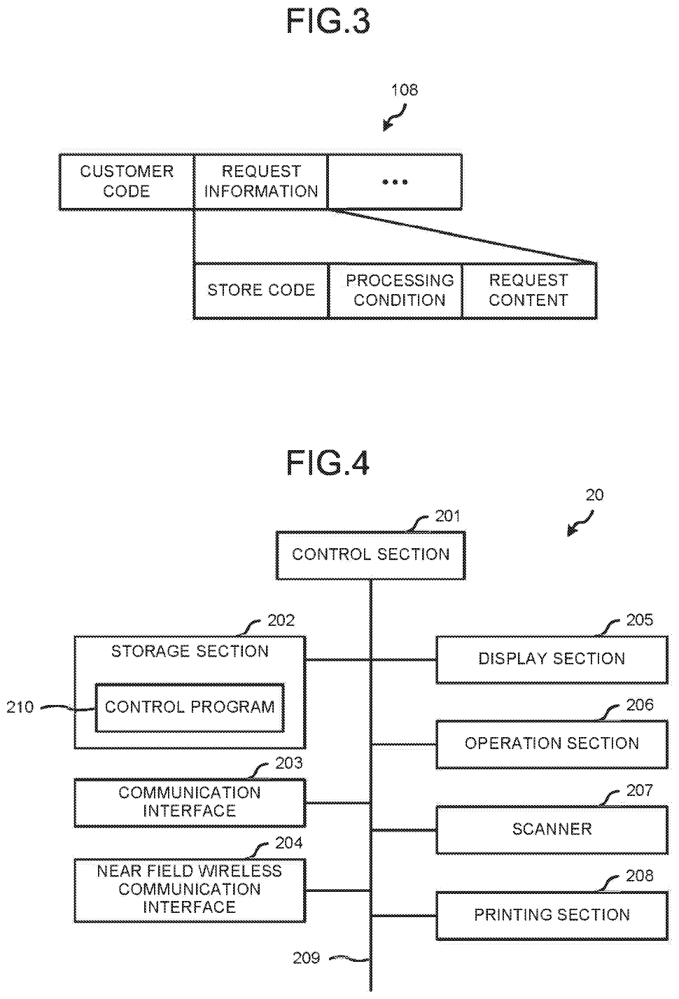

FIG. 1 is a diagram illustrating a customer request system 1 according to the present embodiment. The customer request system 1 includes a customer terminal 10 for inputting a request or a preference of a customer (hereinafter referred to as a customer request), and a POS terminal 20 for receiving customer information 108 (refer to FIG. 3) containing the customer request from the customer terminal 10 via near field wireless communication.

The customer terminal 10 is a portable terminal such as a smartphone, a tablet terminal or a wearable terminal carried by a customer. The customer terminal 10 receives an operation for indicating a customer request, such as whether a receipt is needed or whether a shopping bag is needed. The customer terminal 10 stores the request(s) of the customer who carries the customer terminal 10. Then, when the customer terminal 10 is held over the POS terminal 20, the customer terminal 10 transmits the customer information 108 containing the customer request to the POS terminal 20 via the near field wireless communication.

The POS terminal 20 is a sales data processing apparatus which performs a commodity registration processing for registering a commodity to be purchased and a checkout processing on the commodity registered by the commodity registration processing. When the POS terminal 20 receives the customer information 108 from the customer terminal 10, the POS terminal 20 performs a processing according to the customer information 108.

Next, the hardware structures of various devices included in the customer request system 1 are described.

FIG. 2 is a block diagram illustrating the hardware structure of the customer terminal 10. The customer terminal 10 includes a control section 101, a storage section 102, a communication interface 103, a near field wireless communication interface 104 and a display section 105. These sections are mutually connected via a system bus 106 such as a data bus and an address bus.

The control section 101 is a computer that controls the entire operation of the customer terminal 10 to perform various functions of the customer terminal 10. The control section 101 includes a CPU (Central Processing Unit), a ROM (Read Only Memory), and a RAM (Random Access Memory). The CPU controls the operation of the customer terminal 10. The ROM stores various programs and various kinds of data. The RAM temporarily stores various programs and various kinds of data. The CPU executes a program stored in the ROM or the storage section 102 on the RAM as a work area.

The storage section 102 is a memory device such as a flash memory. The storage section 102 stores a control program 107 and the customer information 108.

The control program 107 is an operating system or a program for performing functions provided by the customer terminal 10. The control program 107 includes a program for performing functions according to the present embodiment.

FIG. 3 is a diagram illustrating a data structure of the customer information 108. The customer information 108 includes various contents of the request by the customer for each retail store. The customer information 108 includes a customer code and one or a plurality of request information. The customer code is capable of identifying the customer. The request information indicates the customer request (s) for each retail store. A store code, a processing condition and request content are associated with the request information. The store code is capable of identifying the retail store. Specifically, the store code is used to identify a store to which corresponding request information is being transmitted. The processing condition indicates a condition for responding to the customer request. The request content indicates the customer request for the corresponding store.

For example, a price of a shopping bag if the customer wants the shopping bag is set as a processing condition, and the request content may be a notification that a shopping bag is not needed/requested. The shopping bag is, for example, a polyethylene bag to be supplied to a customer by the retail store for putting a purchased commodity therein. In this case, the POS terminal 20 displays a message indicating that the shopping bag is not needed if the price of the shopping bag is equal to or greater than the price set in the processing condition.

In another example, the number of purchased commodities is set as a processing condition, and a notification in which the shopping bag is not needed is set as the request content. In this case, the POS terminal 20 displays/indicates that a shopping bag is not needed if the number of purchased commodities is equal to or less than a threshold value.

In another example, a point value (e.g., related to a loyalty program or the like) to be given for shopping at the store is set as the processing condition, and a notification that a paper receipt is to be issued instead of the electronic receipt is set in the request content. In this case, the POS terminal 20 issues a paper receipt instead of an electronic receipt if the point value associated with the shopping is equal to or greater than some threshold value.

In another example, the necessity for an official receipt is set as a processing condition, and a name of a receiver, e.g., personal name or company name, is set in the request content. In this case, the POS terminal 20 issues an official receipt having the name of the receiver as set in the request content if the request for official receipt has been set in the processing condition.

In some examples, there may be no previously set processing conditions. In this case, the POS terminal 20 outputs the request content without determining whether or not any processing condition has been satisfied.

The communication interface 103 is used for establishing communication with other devices via a network.

The near field wireless communication interface 104 is used for establishing communication with an object located within a few centimeters or so. For example, the near field wireless communication interface 104 transmits the customer information 108 when the customer terminal 10 is held over the POS terminal 20.

The display section 105 is, for example, a touch panel display. The display section 105 in such instances detects a touched position on the touch panel to determine that an operation corresponding to a display element shown on the touch panel of the display section 105 is selected.

FIG. 4 is a block diagram illustrating a hardware structure of the POS terminal 20. The POS terminal 20 includes a control section 201, a storage section 202, a communication interface 203, a near field wireless communication interface 204, a display section 205, an operation section 206, a scanner 207 and a printing section 208. These sections are mutually connected via a system bus 209 such as a data bus and an address bus.

The control section 201 is a computer that controls the entire operation of the POS terminal 20 to perform various functions of the POS terminal 20. The control section 201 includes a CPU, a ROM and a RAM. The CPU collectively controls the operation of the POS terminal 20. The ROM stores various programs and various kinds of data. The RAM temporarily stores various programs and various kinds of data. Then, the CPU executes a program stored in the ROM or the storage section 202 on the RAM as a work area.

The storage section 202 is a memory device such as an HDD (Hard Disk Drive) or an SSD (Solid State Drive). The storage section 202 stores a control program 210.

The control program 210 is an operating system or a program for performing functions provided by the POS terminal 20. The control program 210 includes a program for performing functions according to the present embodiment.

The communication interface 203 is used for establishing communication with other devices via a network.

The near field wireless communication interface 204 is used for establishing communication with an object within a few centimeters or so. For example, the near field wireless communication interface 204 receives the customer information 108 when the customer terminal 10 is held over the POS terminal 20.

The display section 205 is, for example, a touch panel display. The display section 205 in these instances detects a touched position on the touch panel to determine that an operation corresponding to a display element shown on the touch panel of the display section 205 is selected.

The operation section 206 can be an input device for receiving various operations, such as a keyboard.

The scanner 207 scans a code symbol such as a barcode and a two-dimensional code.

The printing section 208 comprises a printer that issues a receipt on which various kinds of information relating to a transaction and other information such as a transaction date and time and contact information are printed.

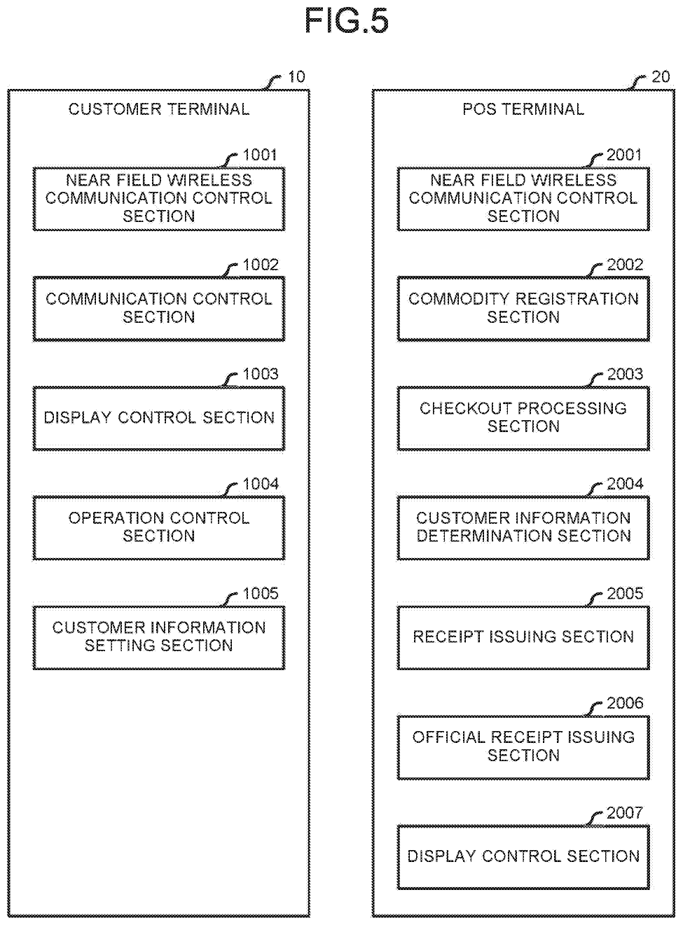

Next, the functions of various devices included in the customer request system 1 are described. FIG. 5 is a block diagram illustrating functional components of various devices included in the customer request system 1.

The control section 101 of the customer terminal 10 loads the control program 107 from the storage section 102 onto the RAM and executes operations according to the control program 107 to generate the functional components shown in FIG. 5. Specifically, the control section 101 of the customer terminal 10 includes a near field wireless communication control section 1001, a communication control section 1002, a display control section 1003, an operation control section 1004, and a customer information setting section 1005.

The near field wireless communication control section 1001 controls the near field wireless communication interface 104 to perform the near field wireless communication. For example, the near field wireless communication control section 1001 controls the near field wireless communication interface 104 to transmit the customer information 108.

The communication control section 1002 controls the communication interface 103 to execute communication with another information processing apparatus or the like. For example, the communication control section 1002 receives the customer information 108 or information for changing (adding or deleting) the customer information 108.

The display control section 1003 controls the display section 105 to display various screens. For example, the display control section 1003 displays an input screen for inputting various contents of the customer information 108 on the display section 105.

The operation control section 1004 controls the touch panel of the display section 105 to receive various operations. For example, the operation control section 1004 receives an operation for setting various contents of the customer information 108 through the input screen described above.

The customer information setting section 1005 sets contents received by the operation control section 1004 through the input screen as the customer information 108. In other words, the customer information setting section 1005 stores the customer information 108 in the storage section 102.

When the communication control section 1002 receives the customer information 108, the customer information setting section 1005 stores the received customer information 108 in the storage section 102 as described above. Further, when the communication control section 1002 receives information for changing the customer information 108, the customer information setting section 1005 changes setting or contents of the customer information 108 stored in the storage section 102 based on the information received by the communication control section 1002.

The control section 201 of the POS terminal 20 copies or decompresses the control program 210 in the storage section 202 on the RAM and operates according to the control program 210 to generate functional components shown in FIG. 5 on the RAM. Specifically, the control section 201 of the POS terminal 20 includes a near field wireless communication control section 2001, a commodity registration section 2002, a checkout processing section 2003, a customer information determination section 2004, a receipt issuing section 2005, an official receipt issuing section 2006 and a display control section 2007.

The near field wireless communication control section 2001 is an example of a receiving module. The near field wireless communication control section 2001 controls the near field wireless communication interface 204 to perform the near field wireless communication. For example, the near field wireless communication control section 2001 controls the near field wireless communication interface 204 to receive the customer information 108.

The commodity registration section 2002 performs the commodity registration processing for registering a commodity to be purchased. For example, the commodity registration section 2002 registers a commodity identified by the commodity code scanned by the scanner 207 or a commodity identified by the commodity code received through the operation section 206 as the commodity to be purchased.

The checkout processing section 2003 performs a checkout processing on the commodity registered by the commodity registration section 2002. For example, the checkout processing section 2003 calculates a total amount due for the commodities registered by the commodity registration section 2002. The checkout processing section 2003 may further calculates a change amount due based on an amount deposited by the customer.

The customer information determination section 2004 determines whether or not the request contained in the customer information 108 received by the near field wireless communication control section 2001 is responded to. More specifically, when the near field wireless communication control section 2001 receives the customer information 108, the customer information determination section 2004 determines whether or not the request information in the customer information 108 includes the store code identifying the retail store in which the POS terminal 20 has been installed.

The customer information determination section 2004 determines whether or not a processing condition included in the request information in the customer information 108 has been satisfied. The customer information determination section 2004 instructs each functional section to handle the request if the processing condition is satisfied. On the other hand, the customer information determination section 2004 does not instruct each functional section to handle the request if the processing condition is not satisfied.

For example, the customer information determination section 2004 determines whether or not the price of a shopping bag if the customer wants the shopping bag in the retail store is equal to or greater than that set in the processing condition, if the price is set in the processing condition and a notification in which the shopping bag is not needed is set in the request content. The customer information determination section 2004 instructs the display control section 2007 to display that the shopping bag is not needed if the price of the shopping bag in the retail store is equal to or greater than that set in the processing condition.

In another example, the customer information determination section 2004 determines whether or not a quantity of purchased commodity is equal to or smaller than that set in the processing condition, if a quantity of purchased commodity is set in the processing condition and a notification in which the shopping bag is not needed is set in the request content. Then, the customer information determination section 2004 instructs the display control section 2007 to display that the shopping bag is not needed if the quantity of purchased commodity is equal to or smaller than that set in the processing condition.

In another example, the customer information determination section 2004 determines whether or not an accumulated point value (e.g., loyalty reward points) is equal to or greater than that set in the processing condition. If the accumulated point value for a transaction is greater than that set as the processing condition and a notification that a paper receipt is to be issued instead of the electronic receipt is set in the request content, then, the customer information determination section 2004 instructs the receipt issuing section 2005 to issue a paper receipt instead of the electronic receipt.

In another example, the customer information determination section 2004 determines whether or not it is set as a processing condition that official receipts must be issued. If the necessity of the official receipt is set as a processing condition and a name of a receiver, e.g., personal name or company name, is set in the request content, then the customer information determination section 2004 instructs the official receipt issuing section 2006 to issue an official receipt containing the name of the receiver set in the request content.

The receipt issuing section 2005, the official receipt issuing section 2006 and the display control section 2007 are examples of an output module. The receipt issuing section 2005, the official receipt issuing section 2006 and the display control section 2007 output the request content included in the customer information 108 received by the near field wireless communication control section 2001. More specifically, the receipt issuing section 2005, the official receipt issuing section 2006 and the display control section 2007 output the request content included in the customer information 108 by executing various kinds of processing in response to the instruction from the customer information determination section 2004. Thus, the receipt issuing section 2005, the official receipt issuing section 2006 and the display control section 2007 output the request content included in the request information having the store code of the retail store in which the POS terminal 20 is installed. Furthermore, the receipt issuing section 2005, the official receipt issuing section 2006 and the display control section 2007 output the request content if the processing condition included in the request information having the store code is satisfied.

The receipt issuing section 2005 controls the issuance of a receipt showing contents of one transaction. The receipt issuing section 2005 controls the printing section 208 to print the receipt when the receipt issuing section 2005 is instructed to issue the paper receipt by the customer information determination section 2004.

The receipt issuing section 2005 transmits transaction information indicating contents of one transaction to an electronic receipt server that generates the electronic receipt when the receipt issuing section 2005 is instructed to issue an electronic receipt by the customer information determination section 2004. The electronic receipt server generates an electronic receipt and transmits it to the customer terminal 10. Thus, the receipt issuing section 2005 generates the electronic receipt. The electronic receipt may be generated by the receipt issuing section 2005 instead of the electronic receipt server. In this case, the receipt issuing section 2005 controls the near field wireless communication control section 2001 to transmit the electronic receipt to the customer terminal 10.

The official receipt issuing section 2006 controls the printing section 208 to control the issuance of an official receipt. The official receipt issuing section 2006 controls the printing section 208 to issue an official receipt that the name of the receiver, e.g., personal name or company name, set in the request content is printed in a name of the receiver (issuing destination) column thereof when the official receipt issuing section 2006 is instructed to issue the official receipt by the customer information determination section 2004.

The display control section 2007 controls the display section 205 to display various kinds of information. For example, the display control section 2007 displays whether or not the shopping bag is needed on the display section 205 when the display control section 2007 is instructed by the customer information determination section 2004 to display whether or not the shopping bag is needed.

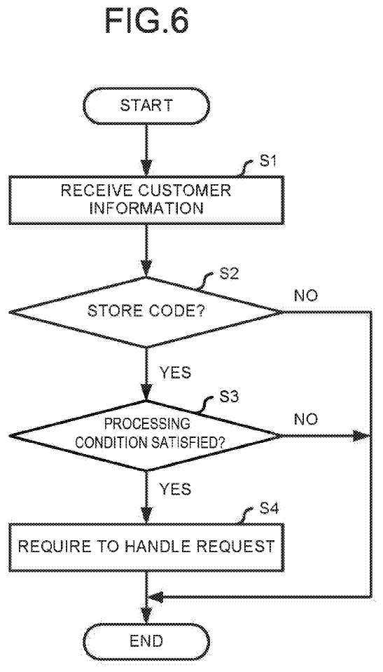

Next, the request handling processing executed by the POS terminal 20 is described. FIG. 6 is a flowchart depicting the request handling processing performed by the POS terminal 20.

The near field wireless communication control section 2001 receives the customer information 108 from the customer terminal 10 (Act S1).

The customer information determination section 2004 determines whether or not the customer information 108 received from the customer terminal 10 includes the request information having the store code for identifying the retail store in which the POS terminal 20 is installed (Act S2).

The POS terminal 20 terminates the request handling processing if the request information having the store code for identifying the retail store in which the POS terminal 20 is installed is not included in the customer information 108 (No in Act S2).

If the request information having the store code for identifying the retail store in which the POS terminal 20 is installed is included in the customer information 108 (Yes in Act S2), the customer information determination section 2004 determines whether or not the processing condition included in the request information is satisfied (Act S3).

If the processing condition is not satisfied (No in Act S3), the POS terminal 20 terminates the request handling processing.

If the processing condition is satisfied (Yes in Act S3), the customer information determination section 2004 instructs each functional section to handle the request associated with the processing condition (Act S4).

Then, the POS terminal 20 terminates the request handling processing.

As described above, the POS terminal 20 according to the present embodiment receives the customer information 108 containing the customer request(s) from the customer terminal 10 in which customer request (s) for each retail store is stored. Then, the POS terminal 20 outputs the customer request(s) contained in the customer information 108. Therefore, the POS terminal 20 according to the present embodiment can quickly receive the customer request(s).

The programs executed by each device of the foregoing embodiments and the modifications thereof may be incorporated into a storage medium (ROM or storage section) in advance; however, the present disclosure is not limited thereto. The programs may be recorded in a computer-readable recording medium such as a CD-ROM (compact disc read-only memory), an FD (Flexible Disk), a CD-R (Compact Disk Recordable), a DVD (Digital Versatile Disk) and the like in the form of installable or executable file. Further, the storage medium is not limited to a medium independent from a computer or an embedded system, and may also be a storage medium that stores the programs by downloading the programs transmitted through a LAN (Local Area Network) or an Internet.

Further, the programs executed by each device of the foregoing embodiments and the modifications thereof may be stored in a computer connected with a network such as the Internet and downloaded via the network or may be distributed via a network such as the Internet.

While certain embodiments of the present invention have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sales data processing system, comprising:
a wireless communication interface configured to receive customer preference information from a customer terminal, the customer preference information including a processing condition associated with a customer preference; and
a controller configured to:
determine whether the processing condition associated with the customer preference is satisfied; and
control a display to display a screen indicating the customer preference upon determining that the processing condition is satisfied.

2. The sales data processing system according to claim 1, wherein
the customer preference information also includes a store code associated with the customer preference, and
the controller is further configured to determine whether the store code matches a store code associated with the sales data processing system.

3. The sales data processing system according to claim 1, wherein
the customer preference information indicates whether a shopping bag is requested, and
the processing condition is a price of the shopping bag being paid.

4. The sales data processing system according to claim 1, wherein
the customer preference information indicates whether a shopping bag is requested, and
the processing condition is the amount of items registered for purchase being less than a threshold amount.

5. The sales data processing system according to claim 1, wherein the controller is configured to control the display to display a first screen indicating a first customer preference upon determining that the processing condition is satisfied and display a second screen indicating a second customer preference upon determining that the processing condition is not satisfied.

6. The sales data processing system according to claim 1, further comprising:
a printer, wherein
the controller is further configured to control the printer to print a paper receipt upon determining that a processing condition is satisfied, and cause an electronic receipt to be generated upon determining that the processing condition is not satisfied.

7. The sales data processing system according to claim 6, wherein
the customer preference information includes a customer identifier,
the customer preference is a printing of the paper receipt, and the processing condition is a threshold accumulated reward points value, and
the controller determines that the processing condition is satisfied when accumulated reward points associated with the customer identifier is exceeds the threshold accumulated reward points value.

8. The sales data processing system according to claim 1, wherein the wireless communication interface is a near-field wireless communication interface.

9. A sales data processing system, comprising:
a wireless communication interface configured to receive customer preference information from a customer terminal, the customer preference information including a processing condition associated with a customer preference;
a printer; and
a controller configured to:
determine whether the processing condition associated with the customer preference is satisfied; and
control the printer to print a paper receipt upon determining that the processing condition is satisfied, and cause an electronic receipt to be generated without printing of the paper receipt upon determining that processing condition is not satisfied.

10. The sales data processing system according to claim 9, wherein
the customer preference is a printing of the paper receipt, and the processing condition is a threshold accumulated reward points value, and
the controller determines that the processing condition is satisfied when accumulated reward points associated with the customer identifier is exceeds the threshold accumulated reward points value.

11. The sales data processing system according to claim 9, wherein the wireless communication interface is a near-field wireless communication interface.

12. A method of operating a sales data processing system, the method comprising:
receiving, through a wireless communication interface, customer preference information from a customer terminal, the customer preference information including a processing condition associated with a customer preference;
determining whether the processing condition associated with the customer preference is satisfied; and
controlling a display to display a screen indicating the customer preference upon determining that the processing condition is satisfied.

13. The method according to claim 12, further comprising:
determining whether a store code in the customer preference information matches a store code associated with the sales data processing system.

14. The method according to claim 12, wherein the customer preference is whether or not a shopping bag is requested.

15. The method according to claim 12, wherein
the customer preference is whether a shopping bag is requested, and
the processing condition is the amount of items registered for purchase being less than a threshold amount.

16. The method according to claim 12, further comprising:
controlling a printer to print a paper receipt upon determining that a processing condition is satisfied; and
causing an electronic receipt to be generated upon determining that the processing condition is not satisfied.

17. The method according to claim 16, wherein
the customer preference information includes a customer identifier,
the customer preference is a printing of the paper receipt,
the processing condition is a threshold accumulated reward points value, and
the printing of the paper receipt is performed only when accumulated reward points associated with the customer identifier exceeds the threshold accumulated reward points value.

18. The method according to claim 12, wherein the wireless communication interface is a near-field wireless communication interface.
